(19) United States
(12) Patent Application Publication
(10) Pub. No.: US 2023/0247976 A1
(43) Pub. Date: Aug. 10, 2023

(54) Method For Trimming Horses' Hooves

(71) Applicant: Karina Lewis, Guernsey, WY (US)

(72) Inventor: Karina Lewis, Guernsey, WY (US)

(21) Appl. No.: 17/668,371

(22) Filed: Feb. 9, 2022

(51) Int. Cl. A01L 15/00

(52) U.S. Cl. CPC A01L 15/00

(57) ABSTRACT

A method for trimming equine hoofs with power tools is disclosed that takes care to measure all four hooves of an equine for symmetry of trimming, then carefully trims regions of the hooves to ideal measurements. In another embodiment, the trimming is done in a specific order and in incremental iterations to ensure a perfect hoof trimming. Used properly, the method realigns the keratin tubules found in the make-up of the hoof horn, or wall, which subsequently has the effect of stimulating healthy formation of laminae. By realigning the hoof improves the equine's: skeletal, circulatory, respiratory, nervous, skin, muscle, digestive, urogenital, and lymphatic systems resulting in their healthy operation.

### CROSS REFERENCE TO RELATED APPLICATIONS

This application claims the benefit of U.S. patent application Ser. No. 16/414,759, filed on May 16, 2019, titled “Improved Method for Trimming Horse's Hooves”; which in turn claims priority to U.S. Provisional Patent Application No. 62/672,460, filed on May 16, 2018, also titled “Improved Method for Trimming Horse's Hooves” both of which are incorporated by reference herein in their entirety for all purposes.

### BACKGROUND OF THE INVENTION

### 1. Field of the Invention

The present invention is in the technical field of equine hoof care. More particularly, the present invention pertains to using power tools and measurements to more effectively trim horses' hooves.

### 2. Description of Related Art

Current systems for equine hoof care do not address the equine as a whole and how its hooves affect the equine. Shoes and improper trimming techniques or lack thereof encourage disease, lameness, inflammation, and pain. Current systems do not measure the collateral groove. Many do not remove excessive bar material or exfoliations of the sole. Current systems have a negative residual effect on the equine as a whole. Current systems decrease the elasticity and energy absorption or expulsion of energy through the hoof, which is vital to an equine's wellbeing. Current systems also cause deformity of the keratin tubules in the hoof, causing painful adhesions and separation of the laminae that leads to disease and deficiencies. Current systems do not act preventively against imbalances, such as unequal or uneven collateral groove depth measurements, standard toe, wall or quarter measurements, inflammation, the restriction of vital blood flow, deformation of laminae, heat or event lines, separation of the laminae, dehydration or hydration of the hoof, flaring, cracks, fractures, proprioception, dental health, improper leverage into the joint and body, gravity, whole body health as it resonates or vibrates with natural frequencies, glial cell inflammation & health, whole body health, and wellness imbalances, sprains or tears in ligaments and tendons or soft tissues, or muscle soreness. Long term use of current methods leads to diseases such as: navicular, ringbone, laminitis, founder, OCD, and more.

The method of equine hoof care described below, “the Lewis Method” herein referred to as (LM) uses power tools and measurements to correct the improper form and function of the hoof through trimming and enables proper function of the hoof, energizing all of the equine's systems. The LM works through understanding the relationship of the hoof to the equine's energy systems: Nervous, circulatory, skeletal, respiratory, digestive, lymphatic, urogenital, skin and muscle. The LM mimics the natural form and function of the wild equine improving the hoof function of the domestic equine. The LM eliminates or reduces disease and inflammation in the equine, curing pain and lameness, and is preventative for sprains, strains, fractures, tendon and ligament injuries, founder, laminitis, flaring, separation of the laminae, laminitis, gravel, seedy toe, bog spavin, wind puffs, OCD, reproductive issues, colic, allergies, navicular, ring bone, and more. The LM eliminates and/or improves behavioral issues due to its ability to provide equines with a pain free existence. The LM also improves health and anatomy such as: proprioception, circulation, metabolism of nutrients, and many kinds of dysfunction in an equine by exciting the glialcell glucose conversion, analyine release, di-sulfide bonding, keratinization process, keratin tubule formation, and restoring homeostasis in the interstitial space.

### SUMMARY

The scope of the present invention is defined solely by the appended claims and detailed description of a preferred embodiment, and is not affected to any degree by the statements within this summary. In general, a method for trimming equine hoofs is disclosed that uses power tool vibrating at specific frequencies and measurements of all four hooves of an equine for symmetry of trimming. Used properly, the method realigns the keratin tubules found in the make-up of the hoof horn, or wall, which subsequently has the effect of stimulating healthy formation of laminae. Realigning the hoof improves the equine's: skeletal, circulatory, respiratory, nervous, skin, muscle, digestive, urogenital, and lymphatic systems resulting in their healthy operation.

### OBJECTS AND ADVANTAGES

The present disclosure of a hoof trimming method can provide a number of advantages for an equine. None of the particular objects or advantages that follow must be entirely satisfied as they are non-exclusive alternatives and at least one of the following objects is met; accordingly, several objects and advantages of the present invention are:

(a) to provide a method for reduction in inflammation resulting in better body mechanics;

(b) to provide a method for reduction in ossification, effusion, and calcification due to stress, wear and tear on bones, connective tissues, ligaments and tendons;

(c) to provide a method for improved behavior and mannerisms;

(d) to provide a method for elimination of biting, bucking, aggression, anxiety, stress, rearing, striking, and kicking;

(e) to provide a method for reduction and elimination of referred pain in muscles and joints;

(f) to provide a method for reduction and correction of lameness and other diseases such as laminitis, founder, ring bone, osteophytes, navicular, colic, allergies, and insulin resistance;

(g) to provide a method for improved circulation and detoxification;

(h) to provide a method for increased stamina and performance;

(i) to provide a method for improved mood and health;

(j) to provide a method for stronger hooves; and

(k) to provide a method for a stronger, happier, and healthier equine overall.

These and other objectives and advantages of the instant invention will become apparent from the following description taken in conjunction with the accompanying drawings wherein are set forth, by way of illustration and example, certain embodiments of the instant invention.

### BRIEF DESCRIPTION OF THE DRAWINGS

Various embodiments are described herein with reference to the following

Drawings. Certain aspects of the Drawings are depicted in a simplified way for reason of clarity. Not all alternatives and options are shown in the Drawings and, therefore, the Claims are not limited in scope to the content of the Drawings.

### Figures

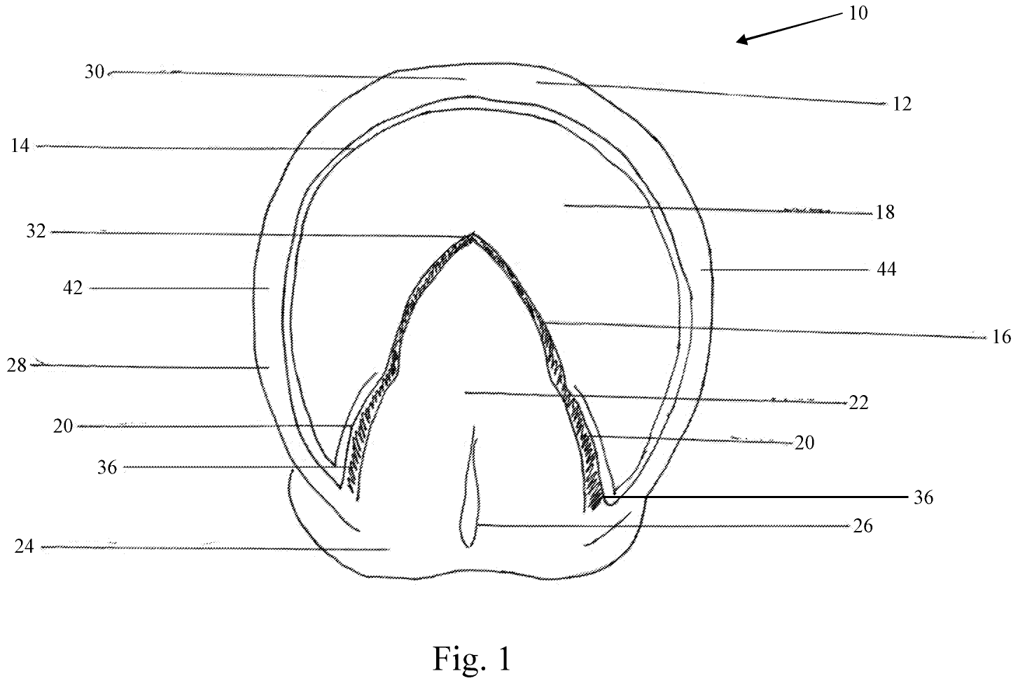

FIG. 1 illustrates a bottom view of an equine's hoof.

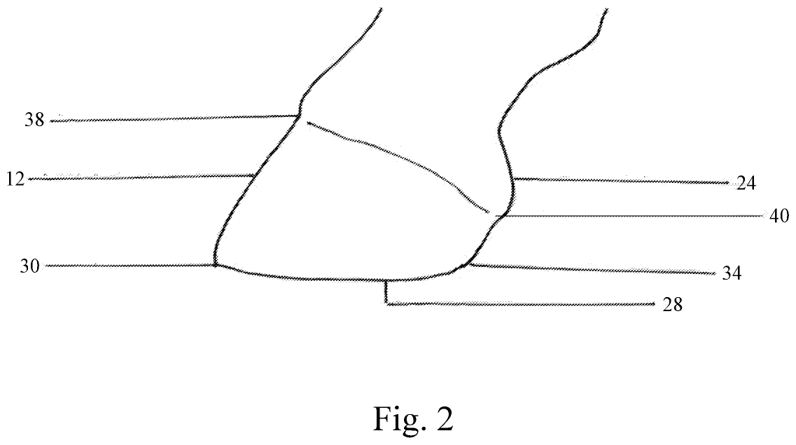

FIG. 2 illustrates a side view of an equine's hoof.

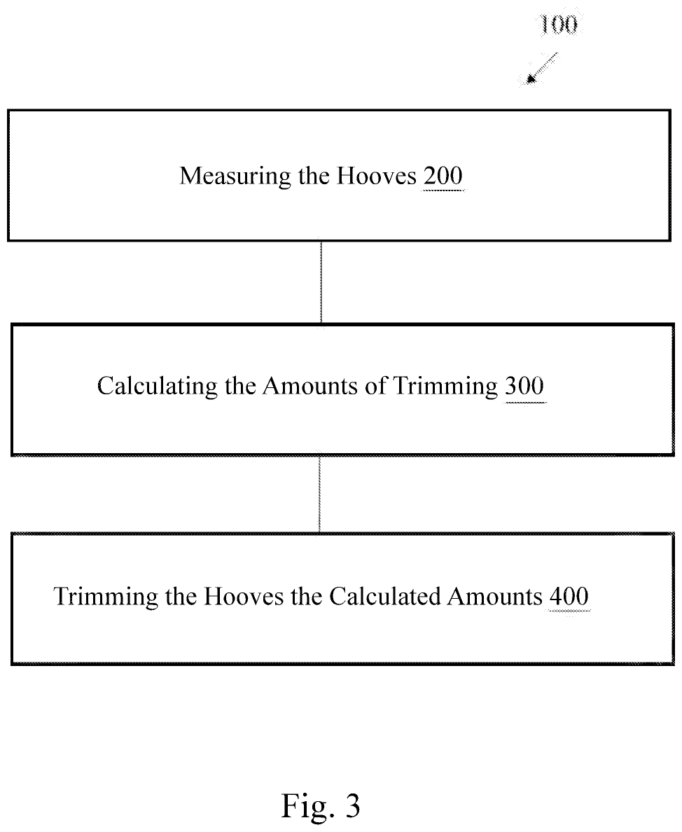

FIG. 3 illustrates a simplified method for trimming an equine's hoof, in accordance with an embodiment of the present disclosure.

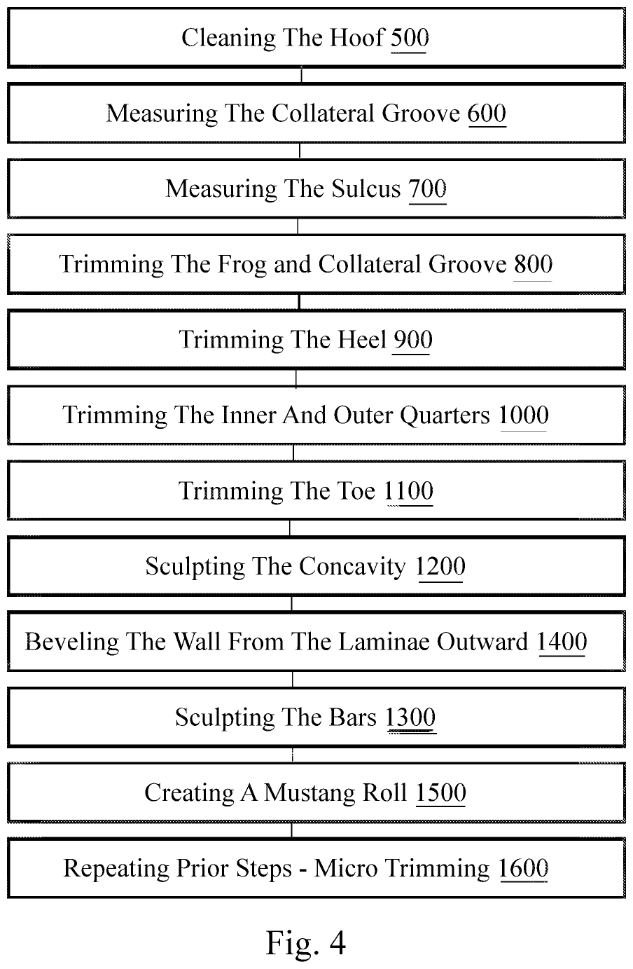

FIG. 4 illustrates a full method for trimming an equine's hoof, in accordance with an embodiment of the present disclosure.

### REFERENCES

10 Hoof
12 Wall
14 White line, or Laminae
16 Collateral Groove
18 Sole
20 Bar
22 Frog
24 Heel Buttress
26 Sulcus
28 Quarter
30 Toe
32 Frog Apex
34 Heel
36 Rear Of The Hoof Where The Frog And The Hoof Meet
38 Coronet Band
40 Top of the Heel
42 Interior Quarter
44 Exterior Quarter
100 The Lewis Method
200 Measuring the Hooves
300 Calculating The Amounts Of Trimming
400 Trimming The Hooves
500 Cleaning The Hoof
600 Measuring The Collateral Groove
700 Measuring The Sulcus
800 Trimming The Frog and Collateral Groove
900 Trimming The Heel
1000 Trimming The Inner And Outer Quarters
1100 Trimming The Toe
1200 Sculpting The Concavity
1300 Sculpting The Bars
1400 Beveling The Wall From The Laminae Outward
1500 Creating A Mustang Roll
1600 Repeating Prior Steps—Micro Trimming

### DETAILED DESCRIPTION

The following description is not to be taken in a limiting sense, but is made merely for the purpose of describing the general principles of exemplary embodiments, many additional embodiments of this invention are possible. It is understood that no limitation of the scope of the invention is thereby intended. The scope of the disclosure should be determined with reference to the Claims. Reference throughout this specification to “one embodiment,” “an embodiment,” or similar language means that a particular feature, structure, or characteristic that is described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

Further, the described features, structures, or characteristics of the present disclosure may be combined in any suitable manner in one or more embodiments. In the Detailed Description, numerous specific details are provided for a thorough understanding of embodiments of the disclosure. One skilled in the relevant art will recognize, however, that the embodiments of the present disclosure can be practiced without one or more of the specific details, or with other methods, components, materials, and so forth. In other instances, well-known structures, materials, or operations are not shown or described in detail to avoid obscuring aspects of the present disclosure. Any alterations and further modifications in the illustrated devices, and such further application of the principles of the invention as illustrated herein are contemplated as would normally occur to one skilled in the art to which the invention relates.

Unless otherwise indicated, the drawings are intended to be read (e.g., arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightward”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate. Also, as used herein, terms such as “positioned on” or “supported on” mean positioned or supported on but not necessarily in direct contact with the surface.

The phrases “at least one,” “one or more,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. The terms “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

Further, all numbers expressing dimensions, physical characteristics, and so forth, used in the specification and claims are to be understood as being modified in all instances by the term “about”. Accordingly, unless indicated to the contrary, the numerical values set forth in the following specification and claims can vary depending upon the desired properties sought to be obtained by the practice of the invention. At the very least, and not as an attempt to limit the application of the doctrine of equivalents to the scope of the claims; each numerical parameter should at least be construed in light of the number of reported significant digits and by applying ordinary rounding techniques. Moreover, all ranges disclosed herein are to be understood to encompass any and all subranges subsumed therein.

For the purposes of promoting an understanding of the principles of the present invention, reference will now be made to the embodiments illustrated in the drawings and specific language will be used to describe the same.

Looking now at FIGS. 1 and 2 which illustrate the bottom and side views of a equine's hoof respectively, the Lewis Method (“LM”) 100 is applied with an understanding of how the equine's hoof is related to all of its major physiological systems: nervous, circulatory, skeletal, respiratory, digestive, urogenital, lymphatic, skin, and muscle. The LM understands that all of these systems relate back to the hoof 10. The LM differs from what is currently available because it seeks to realign the keratin tubules found in the make-up of the hoof horn, or wall 12, which subsequently has the effect of stimulating healthy formation of laminae 14. By realigning the hoof 10, the Lewis Method 100 realigns the equine's: skeletal, circulatory, respiratory, nervous, skin, muscle, digestive, urogenital, and lymphatic systems resulting in the healthy operation of these systems. Realignment and healthy operation allow the equine to be more biomechanically symbiotic in its environment.

Still looking at FIGS. 1 and 2, the LM 100 improves the overall health of the entire hoof 10 and equine through measurement of the collateral groove 16 and removal of excess exfoliated material from the sole 18 and correction of excessive bar 20 growth. Essentially, the LM attempts to mimic the wild equine hoof or “mustang” model. The wild equine's diet and hoof form and function is entirely different than the modern domestic equine. Wild equines do not suffer from the diseases or mobility issues commonly found in domestic stock. The LM differs from what currently exists in that it understands that the hoof of a wild equine is superior in its function due to its environment and therefore has characteristics that aide in the equine's overall benefit. The LM simulates these characteristics in its trimming method, treating the hoof as an organ vital to the equine's survival. LM simulates the hoof form of the wild equine to prevent, not cause disease and lameness.

The LM equine hoof care differs from standard currently practiced hoof trimming in that LM is practiced using power tools that resonate at beneficial frequencies and trimming is done more frequently than with current methods and it is easier to maintain. LM is an improvement as it works with the equine to improve laminae 14 and keratin tubule hoof wall 12 strength. The LM encourages concavity of the hoof capsule, decrease in bar pain/adhesions, reduction and elimination in abscess or sole corium bruising, and increased energy absorption and expulsion. The LM encourages the frog 22 to meet the ground, engaging the palmar nerve and the heel buttress 24 to expand and contract naturally, which causes: increased circulation, decreased inflammation, improved nerve function, decreased pain, and improved proprioception. The LM also improves the fracture strength of the hoof 10, which increases: elasticity of the hoof, energy absorption, expansion of the hoof, and improves blood circulation. Improved blood circulation improves oxygen exchange, which in turn stimulates detoxification. The LM improves the overall health and psychological outlook of the equine, decreasing behavioral issues and improving natural talent and athleticism.

Looking now at FIG. 3, in the simplest embodiment of the LM method 100 it only comprises three Steps: Step (1) measuring the hooves 200; Step (2) calculating the amounts of trimming 300 to be done to the hooves; and, Step (3) trimming the hooves 400.

Step (1) Measuring the hooves 200; should be done after the hooves are thoroughly cleaned and can be done with a gauge by placing the end of the needle into the deepest part of the collateral groove 16 at both sides at the rear of the hoof where the frog meets the hoof 36 and at the apex 32 of the frog 22 (found in the middle of the hoof/frog connection). Measurement with the gauge should be done from the bottom depth of the collateral groove 16 to the top height of the hoof wall 12 (e.g. where it touches the ground). The measurements taken at the rear of the hoof 36 will measure to the top of the hoof wall 12 at the rear of the hoof and the measurement taken at the apex will measure to the toe 30. Generally, the depth of the collateral groove 16 indicates the position of the coffin bone. If the measurement at the rear of the collateral groove 36 is deeper than the measurement at the apex 32 then the coffin bone has rotation. It can also be conversely true. If the measurement of the collateral groove is deeper at the point of measurement at the apex 32 and shallower at the rear point of measurement 36, then coffin bone has also has rotation.

Another possible measurement to be taken in Step (1) is to measure the thickness of the hoof wall 12 at the inside 42 and outside quarters 44. This measurement is taken by measuring from the outside of the hooves wall to the laminae or white line 14. Another possible measurement is length of the hooves from the toe 30 to the heel 34. Another possible measurement is from the toe 30 to the coronet band 38. Another possible measurement is from the quarters 28 to the coronet band 38. Another possible measurement is from the top of the heel 40 to the bottom of the rear of the hoof 34. Another possible measurement is from the top of the bar 20 to the sole 18. Another possible measurement is the width of the white line (Laminae) 14. Another possible measurement is the width of the hoof wall at the rear of the hoof, measuring at widest part of the rear of the heel measuring side-to-side, 34 and 36. Another possible measurement is the depth of the sulcus 26 to the top of the frog 22 (the part that touches the ground).

Step (2), calculating the amounts of trimming 300; the calculation for how much of the hooves should be trimmed is dependent upon the type of animal that is being trimmed. The calculation is made by taking a given measurement and subtracting the ideal size from that measurement, the remainder is the measurement of what needs to be trimmed. If there is no remainder, or the remainder is negative, then that location of the hoof should not be trimmed. When trimming hooves there will likely be a variance from one animal to another and from one trim to another and all ideal measurements are to be taken as also encompassing a range of plus or minus 2 mm.

The following ideal measurements apply to full-grown equines and draft equines; they also apply to large mules, jacks, and donkeys. The ideal depth from the collateral groove 16 at both sides at the rear of the hoof where the frog meets the hoof 36 and at the apex 32 of the frog 22 the collateral groove measurements at both the apex 32 and at either side of the rear of the collateral groove 36 may be 15 mm to 18 mm. The front and rear measurements should be roughly equal so that the coffin bone does not have rotation. The ideal measurement from the toe 30 to the coronet band 38 may be 2.75 inches to 3.5 inches. The ideal measurement from the quarters 28 to the coronet band 38 may be 2.5 inches to 2.75 inches. The ideal measurement from the top of the heel 40 to the bottom of the rear of the hoof 34 may be 7 mm to 8.5 mm. The ideal measurement from the top of the bar 20 to the sole 18 may be 0 mm (flat). The ideal measurement of the thickness of the hoof wall 12 at the inside 42 and outside quarters 44 may be 7 mm to 8 mm. The ideal measurement of the width of the white line (Laminae) 14 may be 4 mm to 6 mm. The ideal measurement of the hoof wall at the rear of the hoof, measuring at widest part of the rear of the heel measuring side-to-side, 34 and 36 may be from 13 mm to 15 mm. The ideal measurement from the depth of the sulcus 26 to the top of the frog 22 (the part that touches the ground) may be 2 mm to 4 mm.

The ideal measurements for miniature equines, ponies, and small hinnies, jack assess, and donkeys is half that of full grown equines. Thus, the ideal depth from the collateral groove 16 at both sides at the rear of the hoof where the frog meets the hoof 36 and at the apex 32 of the frog 22 the collateral groove measurements at both the apex 32 and at either side of the rear of the collateral groove 36 may be 6.5 mm to 7.5 mm. The front and rear measurements should be roughly equal so that the coffin bone does not have rotation. The ideal measurement from the toe 30 to the coronet band 38 may be 1.375 inches to 1.75 inches. The ideal measurement from the quarters 28 to the coronet band 38 may be 1.25 inches to 1.375 inches. The ideal measurement from the top of the heel 40 to the bottom of the rear of the hoof 34 may be 3.5mm to 4.25 mm. The ideal measurement from the top of the bar 20 to the sole 18 may be 0 mm (flat). The ideal measurement of the thickness of the hoof wall 12 at the inside 42 and outside quarters 44 may be 3.5 mm to 4 mm. The ideal measurement of the width of the white line (Laminae) 14 may be 2 mm to 3 mm. The ideal measurement of the hoof wall at the rear of the hoof, measuring at widest part of the rear of the heel measuring side-to-side, 34 and 36 may be from 6.5 mm to 7.5 mm. The ideal measurement from the depth of the sulcus 26 to the top of the frog 22 (the part that touches the ground) may be 1 mm to 2 mm.

Step (3), trimming the hooves 400, may be done with any tool suitable to the task. Ideally the following tools should be used: a high-speed grinder, an electric hoof knife, a power rasp, a hoof pick, a rasp, half rounds, and nippers. Optionally, a mustang roll can be put on the front of the hoof. The hooves are trimmed to the ideal measurements listed above based on the calculations made in Step (2).

In the preferred embodiment, the trimming is accomplished with high speed and frequency power tools operating at between 3,300 and 15,000 revolutions per minute (RPM). Frequency is a way to describe oscillatory motion, such as that by a particle or wave. It describes the time it takes for a motion to repeat itself. It is measured in hertz, which is one oscillation per second. Revolutions per minute denotes circular motion, or the rotations completed by an object around an axis. For motors, the term tells how quickly they can rotate when not under a load. The relevant solfeggio frequency of a motor can be determined by using the equation 1 hertz (Hz) equals 60 revolutions per minute (RPM). Using power tools that operate between 3,000 and 13,000 revolutions per minute produce or 50 and 250 Hertz frequencies that are transmitted directly through the hoof of the horse and into the Palmar nerve running up the horse's leg. It has been proven by scientist Royal R Rife that specific sound frequencies that resonate between 175 Hz and 215 Hz encourage healing and pain relief, with pain relief starting at 175 Hz and with further tissue healing benefits occurring with higher Hertz values.

Ideally, the trimming of step 3 is accomplished using power tools and abrasive surfaces that operate at a frequency within the 175 Hz to 215 Hz range. Grinders and rasps that operate between 10,000 and 13,000 RPM are ideal as they resonate within those ranges. The ideal grinders are 4½″ high speed grinders fitted with 40-grit metal flap disks and long neck anglegrinders fitted with either a 2″ tungsten carbide domed disk rasp. These tools resonate at 175 Hz to 215 Hz frequencies and encourage healing and pain relief in the horse. These tools also leave a smooth surface, making the horse more comfortable and less susceptible to bruises, abscesses, uneven weight bear surfaces.

Additional Steps may be added to these three Steps, or these three Steps may be divided into more Steps, to improve performance of the method; however, no single additional Step is necessary in and of itself or within a sequence of additional Steps; except where one Step necessarily depends upon the prior occurrence of another Step; and Steps may be done one or more times, or a series of Steps may be done in sequence repeatedly before moving to the next Step.

The Steps of a more complex embodiment of the LM method 100 of trimming hoofs may comprise the following Steps:

Step 1, cleaning the hoof 500. A thorough cleaning of the hoof 10 allows for the template of action to be set. It is harder to provide a good and balanced trim of the hooves without removal of debris and exposure of the bottom of the hoof, collateral groove and sulcus of the frog for viewing.

Step 2, measuring the collateral groove 600. The collateral groove 16 is the key element to any proper and balanced trim as it relates directly to the position of the inner boney structures, particularly, the coffin bone, but also the skeletal alignment of the animal. The proper alignment and support of the coffin bone will realign the skeleton and affect the soft tissue structures as well as stimulate the nervous, circulatory, skeletal, respiratory, digestive, urogenital, lymphatic systems, skin and muscle. The sulcus 26 can be measured and articulated by the manipulation of the collateral groove 16 and removal of excess frog 22 materials. The collateral groove 16 depth can be changed by trimming other elements of the hoof 10 such as the bars 20, the frog 22, the sole 18, the walls 12, the quarters 28, the toe 30, or the heel buttress 24.

Careful observation and measurement of the collateral groove 16 after observation and cleaning as referenced in Step 1 on all four hooves prior to trim is important. There are four hooves and proper and balanced trimming leaves a equine as close to symmetrical in collateral groove 16 height as well as frog 22 height, wall 12 height, heel 24 and toe 30 level and height and concavity on all four hooves as possible as the hoof 10 is the primary support structure for the equine and affects the overall well-being and health of the equine. As the hoof is an organ, not an inanimate, separate structure of the equine and has an intimate relation to the equine's circulatory, respiratory, skeletal, respiratory, digestive, urogenital, lymphatic and nervous systems, skin and muscle, the measurement of the collateral groove is critical.

The collateral groove depth should be closely aligned with the measurements that nature would provide and simulated in the trimming process as if the horse were in its native, wild state, while supporting the coffin bone so that it is parallel to the Earth. Horses, like humans, reach homeostasis when the relative body mass is balanced appropriately to align with the Earth's gravity. This is called Equine Gravitational Patterned Alignment. When homeostasis is achieved, and the horse is balanced and healthy on all hooves, the horses' bones, joints, ligaments, muscles, and skeleton will align to optimum health and performance. This process can be audibly noted as the horse's body will crack and pop and is accompanied by the horse licking and chewing, signaling comfort. Health follows. When completed successfully, all horses will exhibit this licking and chewing behavior.

Step 3, measuring the sulcus 700. The sulcus 26 can also be a useful guide in determining the true and eventual conformation of the hoof 10. A hoof with a deep sulcus is a diseased hoof needing therapeutic trimming to bring the equine and hoof back into health. The equine should ideally have a very developed frog that is well calloused, but free from tabs or wings or obstructions. Prior cleaning of the hoof should reveal any loose material that should be removed and debrided. The sulcus of the frog is indicative of the finished trim total height of the frog 22. Removing excess frog 22 material to the lowest depth of the sulcus 26 will enable the frog 22 to contact the ground and stimulate the palmer nerve, setting off a chain reaction of nervous system and interstitial space stimulation aiding in better health for the equine.

The hoof is intimately connected to the myofascial tissues supporting the muscles of horses. The bio-tensegrity of horse's myofascial tissues are determined by the relationship between the hoof health and body posture. The hoof is directly related to the position or orientation of any anatomical point within the tensegrity of the horse. The myofascial systems form a continuous web to connect the whole body. The placement of the frog is critical in determining the integrity of these connections. In other words, the foot can affect and conversely, be affected by the entire musculoskeletal system.

Trimming the frog 22 to the depth of the collateral groove 16 as well as trimming to ensure proper frog height and contact will stimulate the web as well as the inner corium of the sole as well, improving circulation and connection. As the frog 22 is essentially a “pump”, the measurement of the sulcus 26 is critical in setting up the equine to exchange blood and oxygen as well as absorb and dissipate energy during movement. As the frog 22 is also intimate to the palmar nerve, frog debridement and trim techniques are critical in determining the amount of stimulation needed. Good connection begins on the ground, or grounding surface. As the Earth contains a magnetic pull, and vibrational heartbeat known as the Schumann Resonance, the hooves connection, the frog's connection to the Earth in concert with the hooves proper balance and measurement is critical to taking advantage of the health and healing benefits of proper trimming as it affects the entire horse and all its systems.

Understanding how to work within the matrix of myofascial tissues is beneficial to the horse in an untold number of ways. The horse's wellness begins with balanced and proper trimming. The LM is the duplicable map for understanding the curative powers of the natural body of the horse. These results can be seen in the restorative and rehabilitative efficacies demonstrated in the LM method.

Step 4, trimming the frog and collateral groove 800. Measurement of the collateral groove 600 and sulcus 700 allow for the debridement and trim of the frog and heel buttress 800. The frog 22 should be left smooth and absent tabs or adhesions both at the bar 20, heel 34, and heel buttress 24. Not removing this excess material subjects the equine to discomfort and pain. Equally important is debridement of the collateral groove 16, and sole 18 removing adhesions or excess material.

Step 5, trimming the heel 900. Trimming and leveling of the heel 34 lowers the heel 34 and adjusts the depth of the collateral groove 16 while engaging the frog 22. As the heel 34, heel buttress 24, frog 22, and bars 20 are intimate in their functional relationship, care should be taken to trim and evenly level the heels 34, clean and debride the collateral groove 16 where is join the heels; as well as expose the bars, readying them for removal.

If the heels 34 are too high the resulting plane of the coffin bone will not be parallel to the angle of the ground and the frog 22 will not be engaged. Depending on the health of the hoof, trim and leveling off the heels may be aggressive or more passive depending on the environment and nutritional aspects. Trimming of the heels 34 realigns the skeletal structure of the equine and manipulates the biomechanics of the equine as well as other important systems of the equine such as the skin, tissue, tendons, ligaments, muscle, digestive, lymphatic, interstitial space, glial cell reactions, urogenital, circulatory, respiratory, and nervous. Trimming of the heels 34 sets of a chain reaction of how the equine's hoof expands and contracts at the point of impact or contraction upon break over.

Step 6, trimming the inner and outer quarters 1000. Trimming the inner 42 and outer 44 quarters enhances the natural expansion and contraction of the hoof 10, sometimes called “spring”. The quarters 28 may need to be beveled or rasped flat depending on the exercise of the LM 100 in relation to the collateral groove 16 and its realignment or support. The quarters 28 are directly related to other physical elements of the equine and should be trimmed according to their relational impact. Trimming of the quarters should be done so as to increase the function of the hoof and its natural elasticity as well as its impact on the equine's physical body. Quarters that are too high put undue stress on the joints, increasing inflammation and issues with proprioception. Expansion of the hoof as it encounters the ground is necessary as is the expulsion of the energy both absorbed and expelled as the hoof expands then contracts during movement.

Step 7, trimming the toe 1100. Trimming the toe 30 is critical in relation to the collateral groove 16 as the toe 30 or plane of the toe is the marker for measuring the collateral groove and the point of break-over, an element in the overall proprioception of the equine. Trimming the toe is also important in aiding the proper growth of the laminae and hoof/horn. Trimming the toe properly is essential for the overall balance and function of the hoof. Trimming the toe affects the skeletal structure and balance, in particular and coffin bone and phalanx bones. If the heel is high and the toe shallow, no trimming of the toe may be necessary in order to realign the coffin bone. If the toe 30 is long and the laminae 14 separated, it may be necessary to trim and bevel the toe in order to decrease pressure on the coronet band 38 and reduce or eliminate separation of the laminae at its point of origin. If the toe 30 is long it may be necessary to trim and bevel the toe to encourage proper keratin tubule alignment and proper stimulation of the laminae and resulting chain reaction of the circulation of blood throughout the hoof/equine.

Step 8, sculpting the concavity 1200 on the bottom of the hoof through debridement of exfoliated material. Sculpting the concavity on the bottom of the hoof is achieved by removing excess exfoliated material. This can be indicated by observations and removal of “fissures” in the hoof material and debriding to the live sole plane. Sculpting of the bottom of the hoof removes excess debris responsible for inflammation, bruising and interruption of the equine's intimate systems, namely the skeletal, circulatory, respiratory, nervous, skin, muscle, digestive, urogenital, and lymphatic systems. Sculpting the concavity of the hoof reduces stress on the live sole, corium, expansion, and contraction of the hoof 10 and reduces or eliminates stress and pressure into the coronary band, encouraging the formation of keratin tubules, and the healthy keratinization and di-sulfide bonding horsesneed to grow health, intact, connected hooves.

Step 9, sculpting the bars 1300. Removal of the bars to the level of the live sole plane and sculpting of the arch, feathered back into the heel removes any debris from the hoof that can act as an irritant causing bruising, pain, and inflammation; it also creates a clean surface for bearing the weight of the equine. The bars 20 are intimate to the support of the concavity of the hoof as well as being intimately related to the inner structures of the hoof, in particular, to the navicular bone and related nerves. Removal of the bars 20 impacts the equine's nervous system, skeletal system, and causes a chain reaction of processes within the circulatory system which are tied to the skin, muscles, digestive, urogenital, lymphatic, and respiratory systems. Removal of the bar 20 is essential for the overall health and comfort of the equine.

Step 10, beveling the wall from the laminae outward 1400. Beveling the wall 12 from the laminae or white line 14, forward toward the outer wall 12 is necessary to set the bottom ovoid angle for the final stage of creating the outer mustang roll of the wall. Beveling the wall sets the point of break over at the prime weight-bearing surface while reducing resistance to joints, leverage on the coronet band, and reducing stress on the laminae and hoof production. Beveling improves necessary leverage and increases hoof strength. Beveling simulates the superior natural shape as seen in wild equine models.

Step 11, creating a mustang roll 1500. Trim the outer wall into an ovoid mustang roll to simulate the functional strength of the wild hoof model. This trims the keratin tubules into an elliptical shape that is geometrically superior for setting the equine's hoof to resist fracture and cracking by being able to properly dissipate energy absorbed into the hoof. This shape also allows for proper break over and propulsion while allowing the hoof to withstand all manner of trauma from outside elements, dissipating energy without causing harm to the equine.

Step 12, Repeating prior steps—micro-trimming 1600. The following steps can be repeated in multiple micro trims in rapid succession to simulate natural wear and tear, allowing the hoof to adapt. Micro trimming allows the equine's hoof to be debrided in small increments over time. This method improves the equine's overall response to the trim without causing undue stress. Micro trimming can also stimulate the equine's immune and overall systems, essentially therapeutically energizing the equine's systems without over-stimulating them to the detriment of the equine. Rapid micro trims allow the hoof to both adapt and expose areas needing attention for the benefit of the equine. Micro trimming allows the hoof to remain debris free for maximum comfort and benefit to the equine.

The relationship between the equines overall anatomy and the form and function of the hoof are intimate. The hoof is the foundation for the skeletal, circulatory, nervous, digestive, respiratory, urogenital, lymphatic systems, interstitial space, skin, tendons, ligaments, cartilage and muscle functions of the equine and they affect all elements of the equine. The hoof is as an organ and provides extremely vital functions for the equine, its well-being and survival. As the hoof is the primary organ for mobility it is also vital for the equine's circulation as the equine relies on the pumping action of the hoof to “charge” the other systems, such as the circulatory and nervous system which in turn impact the skeletal system. A hoof that is overgrown can impede the equine negatively causing unnecessary leverage on the joints and other structures causing inflammation and pain.

If the collateral groove is not symmetrical in depth measurement then a variety of issues can be present that affect the equine negatively. The keratin or horn may have abnormalities that reduce the equine's overall hoof strength and function as it relates to the rest of the hoof anatomy. Improper depth can mean the laminae are separated. If the laminae are separated the equine will have reduced blood flow in the hoof and may suffer from rotation in the coffin bone. If the collateral groove is not uniform in depth the equine may suffer from a lack of frog contact or contraction reducing the equine's connection with the palmer nerve. If the collateral groove is not uniform the equine will be unable to pump blood back up the leg and an improper exchange of blood and oxygen will occur. If the collateral groove depth is not uniform the equine may require trimming to treat navicular, osteophytes, ringbone, laminitis, founder or more. It may also be necessary to address other issues caused by improper balance of the hoof such as pain, pain in joints, soft tissue, cartilage, ligament and tendon injuries, or arthritis. There are countless variations to this method using the basic method to achieve a hoof that has healthy markers. Unilateral even measurements in the collateral groove depth, clean live sole with no bar obstruction or adhesions, calloused frog, unilateral and uniform thickness of the wall, connected laminae, low heels and balanced toe.

Information as herein shown and described in detail is fully capable of attaining the above-described object of the present disclosure, the presently preferred embodiment of the present disclosure; and is, thus, representative of the subject matter; which is broadly contemplated by the present disclosure. The scope of the present disclosure fully encompasses other embodiments which may become obvious to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address every problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, that various changes and modifications in form, material, work-piece, and fabrication material detail may be made, without departing from the spirit and scope of the present disclosure, as set forth in the appended claims, as may be apparent to those of ordinary skill in the art, are also encompassed by the present disclosure.

1. A method for trimming an equine's hoof comprising the following steps:
Step (1), measuring an equine's hoof; wherein two measurements are taken of a deepest part of a collateral groove on both sides of a rear of a hoof where a frog meets a hoof to a top heigh of a hoof's wall where a hoof touches the ground at the rear of a hoof and a third measurement is taken at a deepest part of an apex of the frog to a top heigh of a hoof's wall where a hoof's toe touches the ground at a front of a hoof;
Step (2), determining if the equine is the size of a full-grown horse, or if the equine is the size of is the size of one of: half the size of a full-grown horse, an adult miniature horse, an adult pony, a small adult hinny, a small jack ass, and a small donkey;
Step (3), trimming; if the equine is the size of a full-grown horse, then trim the hoof down to a live sole plane, creating concavity until said two measurements from the deepest part of a collateral groove on both sides of a rear of a hoof where said frog meets said hoof to said top heigh of said hoof's wall where said hoof touches the ground at the rear of said hoof and said third measurement taken at said deepest part of said apex of said frog to a top heigh of said hoof's wall where said hoof's toe touches the ground at said front of said hoof all measure between 13 mm and 15 mm; if the equine is the size of one of: half the size of a full-grown horse, an adult miniature horse, an adult pony, a small adult hinny, a small jack ass, and a small donkey; then trim the hoof down to a live sole plane, creating concavity until said two measurements from the deepest part of a collateral groove on both sides of a rear of a hoof where said frog meets said hoof to said top heigh of said hoof's wall where said hoof touches the ground at the rear of said hoof and said third measurement taken at said deepest part of said apex of said frog to a top heigh of said hoof's wall where said hoof's toe touches the ground at said front of said hoof all measure between 6.5 mm and 7.5 mm; and
wherein said trimming is done using a power tool that operate between 10,000 and 13,000 revolutions per minute or at frequency between 175 and 215 Hertz providing healthy pain reducing frequencies to said equine's hoof.

2. The method for trimming an equine's hoof of claim 1, wherein said power tool is a high-speed grinder with a 40-grit flap disk.

3. The method for trimming an equine's hoof of claim 1, wherein said power tool is a long neck grinder using a 2″ round tungsten carbide domed disk rasp.

4. The method for trimming an equine's hoof of claim 1, wherein said power tool is an electric hoof knife

5. The method for trimming an equine's hoof of claim 1, wherein said power tool operates at 175 Hz.
